(19) United States
(12) Patent Application Publication
(10) Pub. No.: US 2015/0255057 A1
(43) Pub. Date: Sep. 10, 2015

(54) Mapping Audio Effects to Text

(71) Applicant: Chatfish Ltd., Nahariya (IL)

(72) Inventor: Shoham LEVY, Nahariya (IL)

(21) Appl. No.: 14/692,757

(22) Filed: Apr. 22, 2015

Related U.S. Application Data
(63) Continuation-in-part of application No. 14/085,826, filed on Nov. 21, 2013.
(60) Provisional application No. 61/983,481, filed on Apr. 24, 2014.

(51) Int. Cl. G10L 13/02

(52) U.S. Cl. CPC G10L 13/02; G10L 2013/083

(57) ABSTRACT

A method, system and communication software for communicating an electronic message, the message related to an audio dictionary, the method including: composing a message on a sender terminal including an audio dictionary, the message including at least one set of encoded symbols from the audio dictionary; sending the message from the sender terminal to a receiver terminal; receiving the message at the receiver terminal; and replaying the message on the receiver terminal, such that the replaying includes mapping the at least one set of encoded symbols in the message to a corresponding sound effect in the audio dictionary so that when each of the at least one set of encoded symbols is displayed on the receiver terminal, a respective sound effect is sounded on the receiver terminal.

### FIELD OF THE INVENTION

The present invention relates to audio enhancement of text- and/or symbol-based digital messages over a communications network and, more particularly, to adding audio content to text and/or symbols in multimedia messages.

### BACKGROUND

An emotion icon, better known by the portmanteau emoticon′ is a metacommunicative pictorial representation of a facial expression which in the absence of body language and prosody serves to draw a receiver's attention to the tenor or temper of a sender's nominal verbal communication, changing and improving its interpretation. The emoticon expresses—usually by means of punctuation marks (though it can include numbers and letters)—a person's feelings or mood, though as emoticons have become more popular, some devices have provided stylized pictures that do not use punctuation.

Emoji are the ideograms or smileys used in Japanese electronic messages and webpages, the popular use of which has rapidly spread outside Japan. Originally meaning pictograph, the word emoji literally means “picture” (e)+“character” (moji). The characters are used much like ASCII emoticons or kaomoji, but a wider range is provided, and the icons are standardized and built into the handsets.

Although originally only available in Japan, some emoji character sets have been incorporated into Unicode, allowing them to be used elsewhere as well. As a result, some phones such as the Windows Phone™ and the iPhone™, and the Android™ lines allow access to the symbols without requiring a Japanese carrier.

### SUMMARY OF THE INVENTION

A new level of metacommunication, afforded by the immediate invention, is to provide the text and characters with audio augmentation.

Audio caption—the term “audio caption”, and variations thereof, refers to a short audio clip (e.g. a recording like WAV, MP3, or RAW), or a form of audio generation instructions, such as MIDI, mathematical waves equation, including or excluding random instructions, speech synthesis commands, etc. which are related to computer generated characters. The term ‘audio caption’ will be used interchangeably with the terms ‘audio clip’, ‘audio file’, ‘audio effect’, ‘sound effect (SFX)’ and their variations.

The linguistic term “audio captions” has been borrowed from the concept of a ‘video caption’ which augments the audio content of a visual presentation with text. The caption provides an alternative format by which to deliver audio content. Conversely, an audio caption augments text and visual characters with audio content.

The term “text document” is used herein to refer to an ordered collection of symbols bound together. The term “message” is used interchangeably with the term “text document”. The most common form of such binding is a text document, but it can also be a binary file, an email, a text message, etc. The symbols used in the collection can be an Alphabet, any standard symbol (such as defined in UNICODE), or a specially defined set of symbols such as binary values, or any such defined set of symbols.

Audio captions may be bound to any sequence of symbols (combo) from the document. Symbols in combos cannot overlap. The same symbol can appear in many combos, but not at the same time (place). Example: in one sentence a ‘smiley’ appears in a combo with an adjacent ‘cow’. In the next sentence the smiley appears on its own—making for a different combo. One combo is ‘smiley+cow’, and the other combo is simply a ‘smiley’. Combos may be comprised of adjacent symbols, but not necessarily. A combo may be defined using any method that allows the combo to be identified in a relevant text document—such as using a regular expression. For instance: “abc” is a combo, and a regular expression: “a+b?c+” (which means one or more ‘a’, followed by zero or one ‘b’, followed by one or more ‘c’).

The present invention provides a method and system for sending a text based message, or a text and image (emoticon, emoji, icon etc.) based message from one user of the system to another user of the system via the system server. The message is interpreted based on a predefined audio dictionary, using a mapping methodology. For example, if the word “cat” is included in the message then the message will be ‘read’ (replayed or presented) with the audio caption that is mapped to the word “cat”, e.g. the audio caption of a “meow” sound.

The system provides a public repository which is used by all users. Specific repositories or dictionaries are also available. For example, an ‘MGM’ dictionary may have the word “cat” mapped to the audio caption of Leo the Lion roaring. The message is sent with an indicator that indicates to the receiving user, or user device, which repository to use. If the user or user device does not have the appropriate dictionary then the dictionary can be downloaded from the server.

A user can create a customized dictionary. A customized dictionary (public or private) can be a completely new dictionary, or an edited version of another (public or private) dictionary. There also exists the option of creating a private dictionary. A private dictionary is one type of customized dictionary. In order for a receiver to correctly read the message—as the sender intended, the receiver needs to have access to the private dictionary. Therefore, each private dictionary is uploaded to the central server, but can only be accessed with permission from the generator of the dictionary, i.e. the uploader.

In one preferred embodiment, when the sender sends the message to the receiver, with the indication that the private dictionary is to be used to correctly read the message, e.g. the message must be mapped to dictionary number ‘172283’. In one embodiment, any message sent to a receiver includes inherent permission to access the private dictionary.

In another embodiment, the first message to a user that has not previously received permission to access the private dictionary, the user is inherently providing the receiver with permission to access (and download) the private dictionary. In all subsequent correspondence, the sender merely indicates which dictionary is to be used, without necessarily providing the receiver with permission.

In an extreme exemplary scenario, using the latter embodiment, the immediate system can be used to encode a message, so that even if the message is intercepted, the intercepting arty will not have access to the dictionary that is needed to correctly decipher the message (as long as the it is not the first message which is intercepted but rather any of the subsequent messages). When the message is read by the intercepting party, the text (and/or images) will be mapped, by default, to the public dictionary since the intercepting party does not have permission to access and/or download the private dictionary.

In less extreme, and more common, exemplary scenarios, the private dictionary is merely unavailable to third party users, for privacy reasons and/or so as not to unnecessarily overburden the end-user device with irrelevant dictionaries.

According to the present invention there is provided a method for communicating an electronic message, the message related to an audio dictionary, the method including; composing a message on a sender terminal including an audio to dictionary, the message including at least one set of encoded symbols from the audio dictionary; sending the message from the sender terminal to a receiver terminal; receiving the message at the receiver terminal; and replaying the message on the receiver terminal, such that the replaying includes mapping the at least one set of encoded symbols in the message to a corresponding sound effect in the audio dictionary so that when each of the at least one set of encoded symbols is displayed on the receiver terminal, a respective the sound effect is sounded on the receiver terminal.

According to further features in preferred embodiments of the invention described below the audio dictionary is a default dictionary installed on the sender terminal and the receiver terminal.

According to still further features in the described preferred embodiments the audio dictionary is a customized dictionary, installed initially only on the sender terminal.

According to further features sending the message from the sender terminal to the receiver terminal further includes: instructing the receiver terminal to map the at least one set of encoded symbols to the default dictionary.

According to further features sending the message from the sender terminal to the receiver terminal includes instructing the receiver terminal to map the at least one set of encoded symbols to the customized dictionary.

According to further features the method further includes the step of uploading the customized dictionary from the sender terminal to an online repository, the uploading being performed prior to the step of replaying the message.

According to further features the method further includes the step of downloading the customized dictionary from the online repository to the receiver terminal after receiving the message on the receiver terminal and prior to replaying the message.

According to further features the at least one set of encoded symbols includes at least one encoded symbol selected from the group comprising: an alpha-numeric character, an icon, a smiley, an emoticon, a graphic and an emoji.

According to further features composing further includes the step of generating a customized audio dictionary.

According to further features the composing further includes assigning at least one set of encoded symbols, in the message, to at least one audio dictionary selected from the group comprising: a default dictionary and one or more customized dictionaries.

According to another embodiment there is provided a method for replaying a message received at a receiving terminal from a sender terminal, the message composed on the sending terminal and the message related to an audio dictionary, the method including: replaying the message on the receiver terminal such that the replaying includes mapping at least one set of encoded symbols in the message to a corresponding sound effect in the audio dictionary so that when each of the at least one set of encoded symbols is displayed on the receiver terminal, a respective sound effect is sounded on the receiver terminal.

According to further features the audio dictionary is selected from the group including: a default dictionary installed on the sender terminal and the receiver terminal and a customized dictionary, initially installed only on the sender terminal.

According to further features the method further includes the steps of: uploading the customized dictionary from the sender terminal to an online repository prior to the replaying; and downloading the customized dictionary from the online repository to the receiver terminal after receiving the message on the receiver terminal and prior to replaying the message.

According to another embodiment there is provided a non-transitory computer-readable medium having stored thereon a communication software, the communication software executed by one or more hardware computing processor units, the execution of the communication software by the one or more processor units performing: receiving a message on a receiver terminal, the message composed on and sent from a sender terminal; and replaying the message on the receiver terminal, such that the replaying includes mapping the at least one set of encoded symbols in the message to a corresponding sound effect in the audio dictionary so that when each of the at least one set of encoded symbols is displayed on the receiver terminal, a respective sound effect is sounded on the receiver terminal.

### BRIEF DESCRIPTION OF THE DRAWINGS

Various embodiments are herein described, by way of example only, with reference to the accompanying drawings, wherein:

FIG. 1 is a simplified block diagram including a sender terminal or client, a receiver terminal/client and an online server;

FIG. 2 is a representation of a message as replayed using a customized dictionary;

FIG. 3 is a representation of a message as replayed using a default dictionary;

FIG. 4 is a flow chart detailing the process of sending an audio/visual message using a default dictionary;

FIG. 5 is a flow chart detailing the process of sending an audio/visual message using a customized dictionary;

FIG. 6 is a flow chart detailing the process of sending an audio/visual message using explicit dictionary assignment;

FIG. 7 is a schematic diagram of a processing unit according to the immediate invention.

### DESCRIPTION OF THE PREFERRED EMBODIMENTS

The principles and operation of a method and system of mapping audio captions to text in an electronic message, according to the present invention, may be better understood with reference to the drawings and the accompanying description.

For the sake of clarity, the term “encoded symbols” can refer to any alpha-numeric character, icon, graphic, emoticon, emoji, smiley that is digitally represented in an electronic message. The phrase “set of encoded symbols” refers to one or more symbols that feature consecutively in a predefined manner. That is to say that a single symbol is understood to be a set. A group of symbols can also be a single set, where the symbols are recognized as a single term in the dictionary related to a single audio file. For example, three consecutive ‘thumbs up’ emoji can be a single term in the dictionary which is mapped to the audio file which sounds a recording of an expressive voice saying the work “awesome”.

An “electronic message” refers to any type of digitized message that is character based (i.e. made up of encoded symbols) that can be sent from one computing device to another computing device. Some common examples of electronic messages (also referred to herein simply as messages) are SMS messages, Multimedia Messaging Service (MMS) messages, emails, instant messaging, social messaging (e.g. BlackBerry Messenger™, Facebook Messenger™, KakaoTalk™, Line™, WeChat™, and WhatsApp™) and the like.

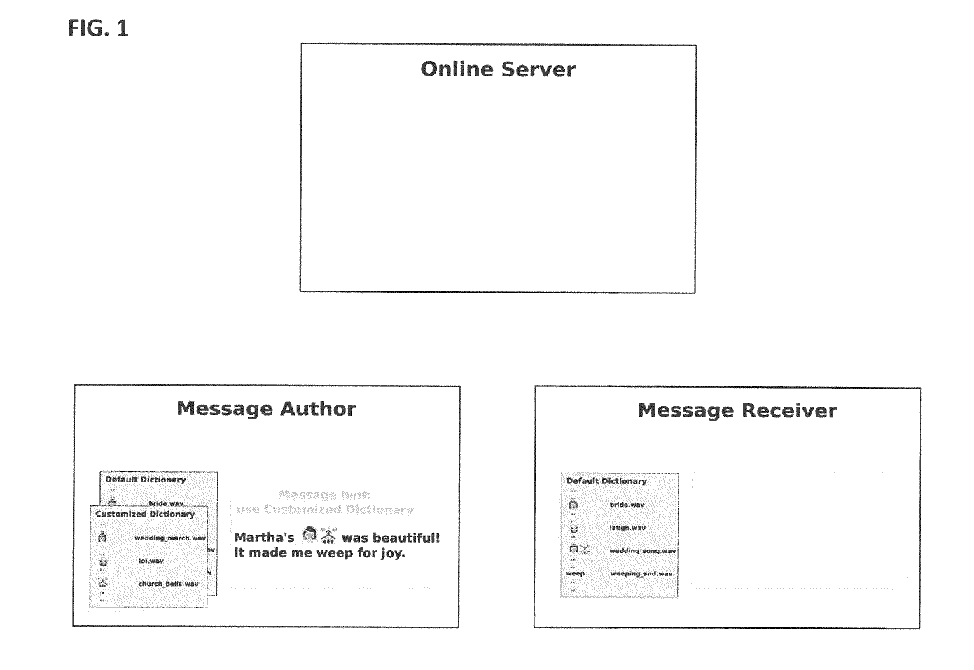

Referring now to the drawings, FIG. 1 illustrates a simplified block diagram including a sender terminal or client 110, a receiver terminal/client 120 and an online server 130 that serves as a repository for the customized dictionaries. The online server may or may not be the same server that handles the communication (sending and receiving) of the electronic messages themselves. The function of a separate message server, or a messaging functionality of the online server, can be performed by any relevant messaging technology known in the art (e.g. email servers, Short Message Service Center or SMSC, Facebook Messenger™, Viber™ etc.).

In one exemplary embodiment, the aforementioned system includes three pieces of software: the sending client, the server, and the receiving client. In some embodiments, the sending and receiving clients still have two different functionalities, but can be performed by the same software. The server system is usually based on separate software.

In the exemplary scenario of FIG. 1, sender terminal 110 is the message author. The sender terminal has a default dictionary 112 installed thereon. The receiver terminal also has a copy of the same default dictionary 122 installed thereon. The default dictionary, as the name suggests, is the dictionary that comes together with the messaging package and is used as the default dictionary for mapping sounds to the various symbols in the message.

Sender terminal 110 further includes a customized dictionary 114 that is different from the default dictionary. At this point, the customized dictionary is not installed on receiver terminal 120. A message 116 is composed on the sender terminal. The message includes text as well two emojis, a bride and a church.

The following exemplary selection methods are used to assign sound effects to words and words to dictionaries:

Automatic Selection: In one embodiment of the invention, any and all text or symbols (referred to hereafter as “encoded symbols”) or set of encoded symbols that is found in the dictionary that is being used (either default or customized) is automatically related to or, more precisely, mapped to the audio file/sound effect (SFX) corresponding to that set of encoded symbols.

Manual Selection: In another embodiment, the symbols or sets of symbols must be selected by the composer in order for the symbol or symbols to be mapped to the corresponding audio file. The dictionary that the author maps the sets/sequences to can be the default dictionary or a customized dictionary.

Explicit Dictionary Assignment: Explicit assignment is the use of manual selection when more than one dictionary is used in a single message. The author can explicit assign any dictionary to specific words. If, for instance, the author wants a sound just for the word ‘thumbs’, which is usually tied to “thumbs up” in the default dictionary, the author defines a new, custom dictionary with just the word ‘thumbs’ in it. Then the author explicitly assigns this new (customized) dictionary to the word ‘thumbs’. This way the word ‘thumbs’ is looked up in the customized dictionary, and is not part of the phrase ‘thumbs up’ of the default dictionary. Of course this explicit dictionary assignment is just for the specified word, but in another place in the document/message the phrase ‘thumbs up’ will be defined as in the default dictionary.

The message also includes a Message Hint 118 which may or may not be visibly represented on the receiver terminal. For example, the message may include code which instructs or informs the receiver terminal as to which dictionary to use when ‘replaying’ (i.e. when displaying the symbols and playing the audio effects) the message. The message hint is referred to herein as an ‘indicator’, as it indicates which dictionary to use. The indicator may be sent in any fashion known in the art. For example, the indicator may be sent in the same message (as mentioned above), in a second message, as visible text, as invisible instructions, etc.

In the exemplary scenario, the message hint indicates that the customized dictionary 114 must be used, instead of the default dictionary. In some embodiments, a hint, or indicator, is always necessary, whether using the default dictionary or a customized one. In other embodiments, an indicator is sent only when a customized dictionary is used, but when no indicator is sent then the default dictionary is used. The default dictionary may also be used when the customized dictionary cannot be found, accessed, downloaded etc. Furthermore, the indicator preferably includes a reference to which customized dictionary is supposed to be used, as more than one customized dictionary may exist.

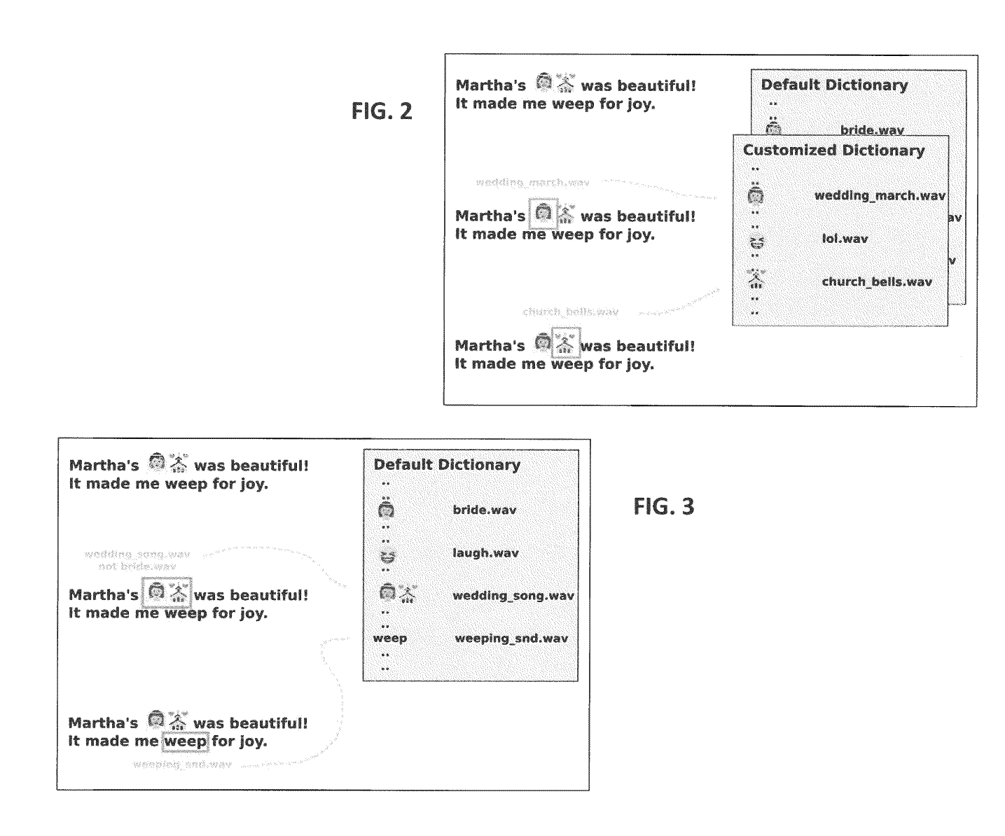

FIG. 2 illustrates message 116 as replayed using the customized dictionary. The message reads as follows: “Martha's {emoji of a bride}{emoji of a church} (understood to replace the word “wedding”) was beautiful! It made me weep for joy.” The customized dictionary maps the ‘bride’ emoji to an audio file labeled ‘wedding_march.wav’ and the ‘church’ emoji is mapped to the audio file labeled ‘church_bells.wav’. Therefore, when the ‘bride’ emoji is displayed on the receiver terminal, the wedding_march.wav sound will play, and when the ‘church emoji is displayed the church_bells.wav sound will play.

If the receiver terminal 120 receives message 116 without the hint, for example, then the message will be mapped to the default dictionary 122. FIG. 3 illustrates message 116 as mapped to default dictionary 112/122. It is noted that the default dictionary 122 maps the ‘bride’ emoji to an audio file labeled ‘bride.wav’. On the other hand, the set of encoded symbols consisting of the ‘bride’ and ‘church’ emojis is mapped to a different audio file, this one labeled ‘wedding_song.wav’. In the Automatic Selection embodiment, if the ‘bride’ emoji is written by itself then the bride.wav sound will be played when the ‘bride’ emoji is displayed on the receiver terminal; but, in the current message the ‘bride’ emoji is immediately followed by the ‘church’ emoji, so in this case the wedding_song.wav sound is played.

However, in the Manual Selection embodiment, the composer can select one or both emojis. In the exemplary scenario, the composer selects both emojis together, indicating to the system that the wedding_song.wav sound must be played when the emojis are displayed.

The word “weep” is also a term in the default dictionary. According to the Automatic Selection embodiment (whereby every set of symbols in the message that is one of the terms in the dictionary is automatically mapped to the corresponding audio effect) the word weep automatically invokes the sound stored in the ‘weeping_snd.wav’ file in the default dictionary. In the Manual Selection embodiment (where the composer selects which sets of encoded symbols are mapped to the dictionary so that only some of the sets invoke sounds while others do not, even if those terms are also found in the dictionary), the composer must actively select the term that is to be associated the sound.

It is made clear that not all the inherent steps and features needed for the following methods are included in the following description but rather only the steps and features that are germane to the invention and/or are necessary for the clear understanding of the systems and processes are described herein.

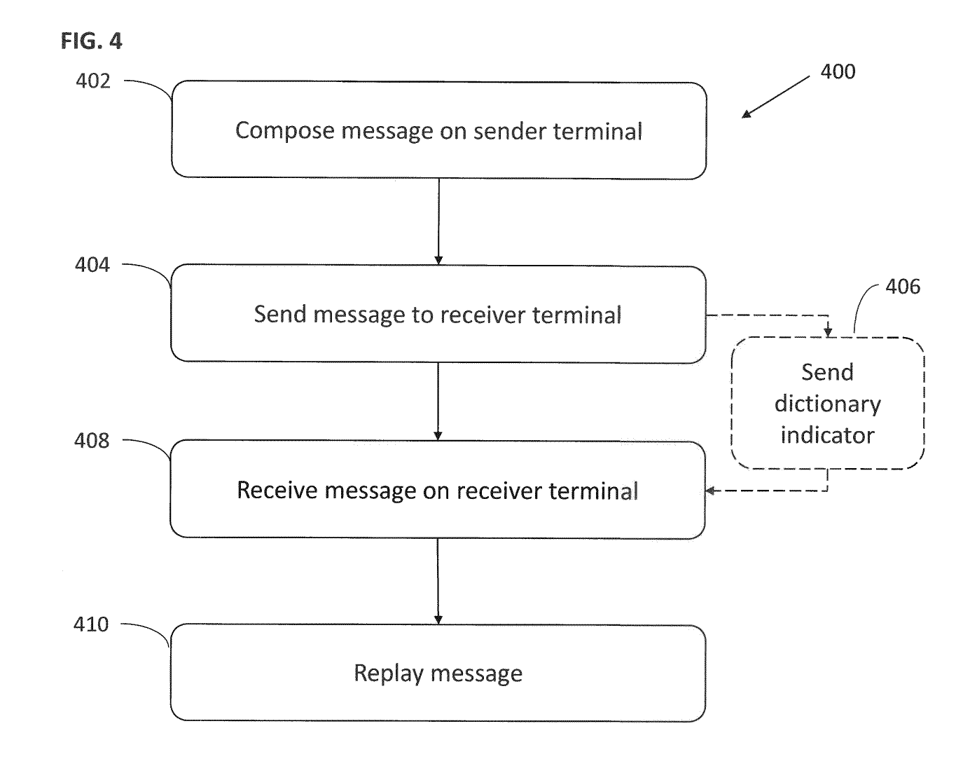

FIG. 4 illustrates a first exemplary flow chart 400 of the process for communicating and replaying an electronic message with audio sounds/captions mapped to at least part of the message. The procedure for, or method of, facilitating the communication of electronic messages that include characters and/or symbols that are mapped to audio files of a default dictionary includes the following steps:

Step 402 includes composing a message on the sender terminal. The sender terminal has the relevant audio dictionary installed on the terminal. The audio dictionary may be the default dictionary or a customized dictionary. The current invention can be implemented in any terminal to terminal messaging program such as email, SMS messaging (also known as ‘texting’), instant messaging (IM) and the like. For example, if the terminal is desktop or laptop PC, the software application can be an email application that is installed on the computer and includes at least the default dictionary. In another example, the terminal can be a mobile handset such as a smartphone. The current invention can be implemented as an SMS or MMS application. The application is installed on the device and includes at least the default dictionary.

The message composed on the sender terminal includes at least one set of encoded symbols. A set of encoded symbols can include a single character or icon. The set of encoded symbols (or simply ‘set’) is a reference or term that is found in the audio dictionary, where the dictionary pairs each term with an audio file. In the Manual Selection embodiment discussed above, the author of the message must also select each set or term to indicate that the corresponding audio file is to be played when that set if displayed. The author of the message also selects the dictionary to be used (in the immediate flow, the default dictionary is used).

In Step 404 the electronic message is sent from the sender terminal to the receiver terminal.

In step 406 an indicator is sent to the sender terminal indicating which dictionary is used. In some embodiments on the invention, if the default dictionary has been used then no indicator needs to be sent with the message. However, in other embodiments, even if the default dictionary is used, an indicator must be sent when the message is sent. (If a customized dictionary is used, then an indicator must sent specifying which customized indicator was used.) Step 406 is therefore an optional step (designated as such by using a broken line border and arrows).

In step 408 the message is received at the receiver terminal. If an indicator was sent, then the indicator is also received at the receiver terminal.

In step 410 the message is replayed on the receiver terminal. The term ‘replayed’ is used to encompass both the visual aspects of the message and the audio aspects of the message. In one preferred embodiment, the symbols of the message are displayed on the receiver terminal in a serial manner, part by part over time (e.g. with half a second interval between each work), instead of being displayed all at once (as is the norm with emails, IMs, SMSs and the like). In this manner, as soon as a word or symbol that has an audio component is displayed, the audio file is sounded (or ‘played’). The aforementioned method makes the greatest impact on the reader.

In further detail, the process works as follows: each set of encoded symbols in the message is mapped to the corresponding audio clip/file as defined in the relevant audio dictionary. As each set of encoded symbols is displayed on the terminal, the respective corresponding audio clip is sounded on the terminal.

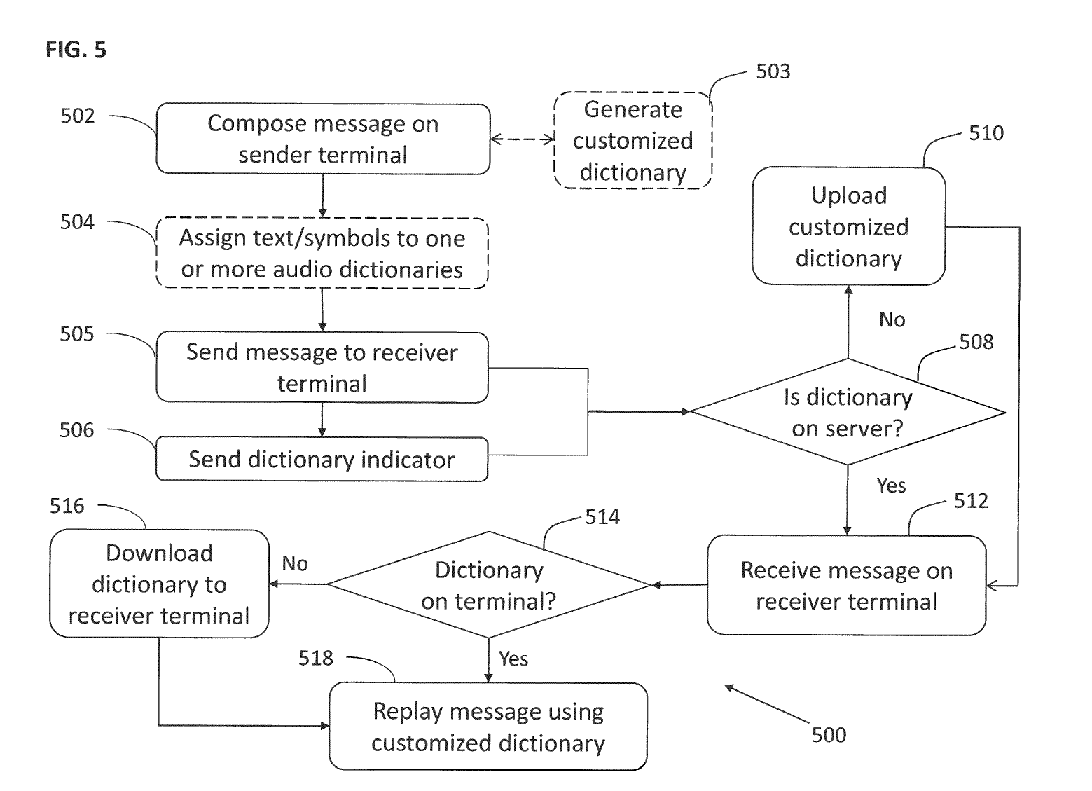

FIG. 5 illustrates a flow chart 500 detailing the process of sending an audio/visual message using a customized dictionary.

In Step 502 the message is composed on the sender terminal. The author indicates that a customized audio dictionary is used. In the Manual Selection embodiment, the author selects the desired sequences/sets of encoded symbols from the message and relates the sets to the customized dictionary terms, each term with the corresponding audio clip/effect.

In some embodiments, the author generates a customized dictionary in step 503. The author can use the default dictionary, a customized dictionary and/or more than one customized dictionary. If more than one dictionary is used in a single message then the terms must be specifically assigned to the desired dictionary.

As discussed above (see Explicit Dictionary Assignment) the sets can be assigned or bound to more than one dictionary. E.g. some of the sets or sequences of the messages are (automatically or manually) related to the default dictionary while other sets can be assigned (by the author) to one or more customized dictionaries. Optionally, in step 504 the author assigns at least one set of encoded symbols in the message to at least one audio dictionary. The audio dictionaries can be the default dictionary and/or one or more customized dictionaries. I.e. each term can be assigned to either the default dictionary or one of the customized dictionaries (including a customized dictionary generated by the author). In summary, the assigning of terms can be done automatically, manually or semi-automatically (i.e. some terms assigned automatically and some assigned manually).

In step 505 the message is sent from the sender terminal to the receiver terminal.

In step 506 an indicator is sent from the sender terminal indicating which customized dictionary is used. In some embodiments the indicator is sent together with the message, making steps 505 and 506 a single step. In other embodiments, the process includes two distinct steps as shown.

A customized dictionary must be uploaded to the online server. Once the customized dictionary is uploaded once, there is generally no need to upload the same dictionary a second time. Therefore, in step 508 the sender terminal determines whether the immediate customized dictionary is already on the server or not.

If the customized dictionary is not on the server, then in step 510 the sender terminal uploads the customized dictionary to the online server. If the customized dictionary is already stored on the online server/repository then step 510 is skipped.

In step 512 the receiver terminal receives the message and the indicator, then, in step 514 the terminal checks to see in the indicated dictionary is installed on the terminal. If the customized dictionary that is referred to by the indicator is not on the receiver terminal, then that dictionary is downloaded from the online repository in step 516. However, if the customized dictionary is already installed on the receiver terminal then step 516 is skipped.

In any case, once the customized dictionary is installed on the receiver device, then the message is replayed on the receiver device in step 518. The process for replaying the message is substantially the same as the process described above for FIG. 4, and is therefore not repeated here.

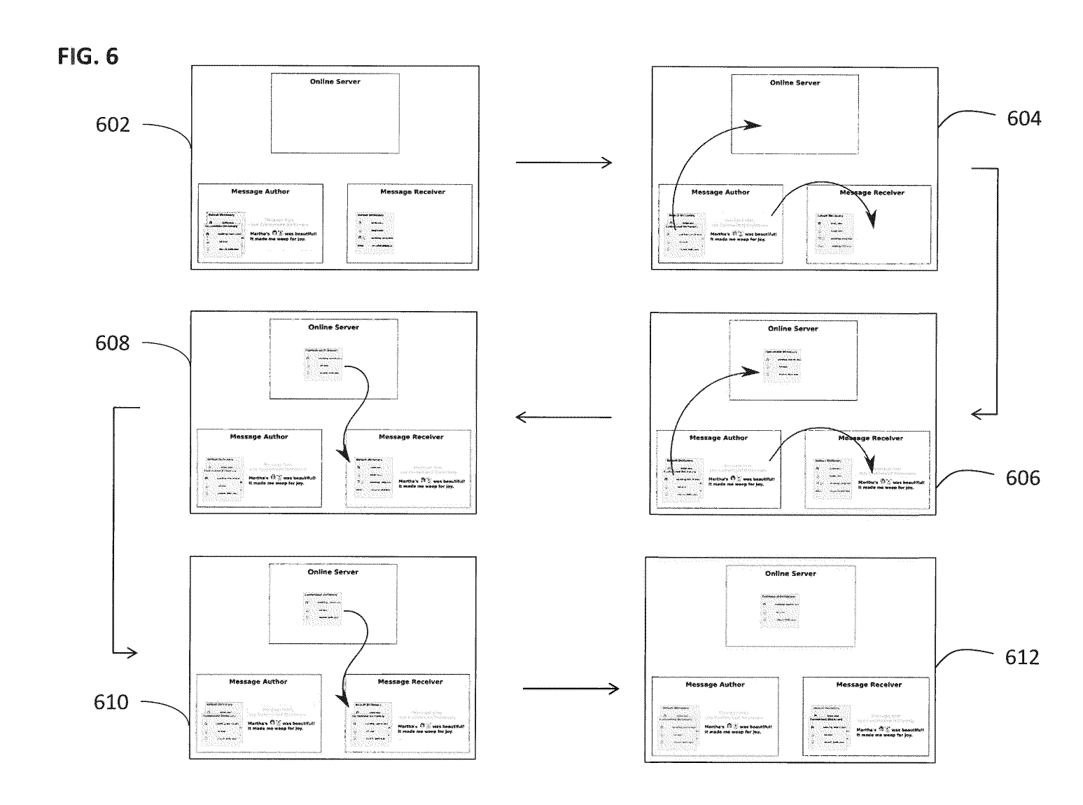

FIG. 6 is a pictorial flow diagram detailing the process of sending a message according to the immediate invention, using explicit dictionary assignment. In step 602 the author composes a message on the sender terminal which has communications software installed thereon which is executed by one or more processing units. The software includes the default dictionary. For example, the sender and receiver terminals are smartphones with messaging applications installed thereon.

In the depicted example, the message includes a ‘bride’ emoji and a ‘church’ emoji. In the immediate example, the author of the message explicitly assigns both emojis to the customized dictionary. The word “weep” is automatically assigned to the default dictionary.

In step 604 the message is sent to the receiver device. The receiver terminal also has the messaging (communications) software installed thereon, including the default dictionary. The customized dictionary is sent (uploaded) to the online server. In step 606 the customized dictionary arrives at the online server and the message arrives at the receiver terminal.

In step 608 the customized dictionary to which the emoji characters where assigned is downloaded to the receiver terminal. In step 610 the customized dictionary is installed on the receiver terminal. The message can now be replayed on the receiver terminal.

In step 612 the message is replayed on the receiver terminal. Exemplarily, the message is replayed in the following manner: the word “Martha's” first appears on the smartphone display. Then the ‘bride’ emoji appears on the screen. At the same time the wedding march tune (wedding_march.wav from the customized dictionary) plays on the device speaker. Next the ‘church’ emoji appears and the sound of church bells ringing (from church_bells.wav from the customized dictionary) issues from the speaker. The words “was beautiful! It made me” next appear in succession. Then the word “weep” appears on the screen together with a weeping sound effect (weeping_snd.wav from the default dictionary). Finally the words “for joy.” Appear on the screen, concluding the message.

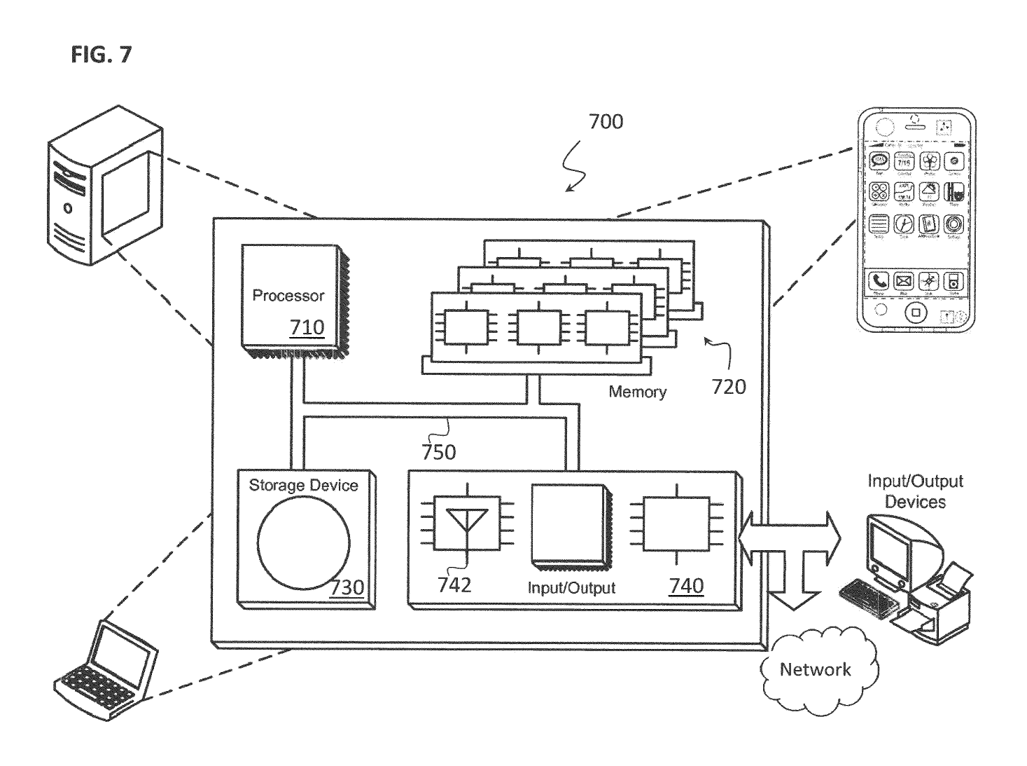

FIG. 7 illustrates a schematic diagram of a processing unit 700 according to the immediate invention. The processing unit is exemplary shown as the processing unit of a PC, laptop or smartphone. Of course, other computing devices are included within the scope of the invention. The processing unit 700 can be used for the operations described in association with any of the computer-implement methods and devices described herein, according to one implementation. The processing unit 700 includes a processor 710, a memory 720, a storage unit 730, and an input/output controller 740. Each of the components 710, 720, 730, and 740 are interconnected using a system bus 750. The processor 710 is capable of processing instructions for execution within the processing unit 700. In one implementation, the processor 710 is a single-threaded processor. In another implementation, the processor 710 is a multi-threaded processor. The processor 710 is capable of processing instructions stored in the memory 720 and/or on the storage device 730 to display graphical information for a user interface on the input/output device 740.

Memory 720 stores information within processing unit 700. Memory 720 is a non-volatile memory unit. Storage device 730 is capable of providing mass storage for the computing device. In one implementation, the storage device 730 is a computer-readable medium. In various different implementations, the storage device 730 may be a flash drive device, an SD card, a micro SD card, a hard disk device, an optical disk device, or a tape device.

The input/output controller or communications unit 740 provides input/output operations for processing unit 700. In one implementation, input/output device 740 includes or is coupled to one or more of: a keyboard, a pointing device (not shown), a sound input device (e.g. a microphone (not shown)), an imaging device (e.g. a camera (not shown)), a touch sensitive input device (e.g. a touch screen (not shown)), a wireless/remote communication device (not shown) and any other type of Human Interface Device (HID). Furthermore, I/O control 740 handles all communications between the device and external or extrinsic mechanisms. For example, I/O 740 can couple the device to a local or wide area network or a cellular data/voice network in a wired or wireless manner, by connecting to a router or over a cellular data network. Exemplarily, Antenna 742 may enable local wireless communication or remote wireless communication (e.g. WiFi, cellular capabilities) or both. In another implementation, the input/output device 740 includes or is operationally coupled to a display unit (e.g. a slave display/monitor, touch screen) for displaying graphical user interfaces and/or data.

I/O 740 couples the computing device directly or indirectly to a Network. The network can be a wireless network, a computing network, a cellular (data and/or voice) network, and the like.

The features described herein can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer includes any computing device including a hardware processor capable of interpreting computer-readable instructions and implementing them. Examples of computing devices or computers include, desktop PCs, laptops, PDAs, beepers, smartphones, cellphones, tablet computers, mini-tablets, wearable computing and/or communications device and the like. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a primary and/or secondary device are a processor for executing instructions and one or more memories for storing instructions and data. Generally, a computing device will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a primary or secondary computing device having a display device such as a CRT (cathode ray tube) or LCD (liquid crystal display) monitor for displaying information to the user and a keyboard and a pointing device such as a mouse or a trackball by which the user can provide input to the computer. Alternatively, the input and display devices can both be embodied on a touch-sensitive surface, such as the touch screen of a tablet or smartphone.

The features can be implemented in a computer system that includes a back-end component, such as a data server, or that includes a middleware component, such as an application server or an Internet server, or that includes a front-end component, such as a client computer, mobile device (terminal) etc. having a graphical user interface or an Internet browser, or any combination of them. The components of the system can be connected by any form or medium of digital data communication such as a communication network. Examples of communication networks include, e.g., a LAN, a WAN, cellular data network, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for communicating an electronic message, the message related to an audio dictionary, the method comprising:
composing a message on a sender terminal including an audio dictionary, said message including at least one set of encoded symbols from said audio dictionary;
sending said message from said sender terminal to a receiver terminal;
receiving said message at said receiver terminal; and
replaying said message on said receiver terminal, such that said replaying includes mapping said at least one set of encoded symbols in said message to a corresponding sound effect in said audio dictionary so that when each of said at least one set of encoded symbols is displayed on said receiver terminal, a respective said sound effect is sounded on said receiver terminal.

2. The method of claim 1, wherein said audio dictionary is a default dictionary installed on said sender terminal and said receiver terminal.

3. The method of claim 1, wherein said audio dictionary is a customized dictionary, installed initially only on said sender terminal.

4. The method of claim 2, wherein sending said message from said sender terminal to said receiver terminal further includes:
instructing said receiver terminal to map said at least one set of encoded symbols to said default dictionary.

5. The method of claim 3, wherein sending said message from said sender terminal to said receiver terminal includes instructing said receiver terminal to map said at least one set of encoded symbols to said customized dictionary.

6. The method of claim 5, further comprising the step of uploading said customized dictionary from said sender terminal to an online repository, said uploading being performed prior to said step of replaying said message.

7. The method of claim 6, further comprising the step of downloading said customized dictionary from said online repository to said receiver terminal after receiving said message on said receiver terminal and prior to replaying said message.

8. The method of claim 1, wherein said at least one set of encoded symbols includes at least one encoded symbol selected from the group comprising: an alpha-numeric character, an icon, a smiley, an emoticon, a graphic and an emoji.

9. The method of claim 1, wherein said composing further includes the step of generating a customized audio dictionary.

10. The method of claim 1, wherein said composing further includes assigning at least one set of encoded symbols, in said message, to at least one audio dictionary selected from the group comprising: a default dictionary and one or more customized dictionaries.

11. A method for replaying a message received at a receiving terminal from a sender terminal, the message composed on the sending terminal and the message related to an audio dictionary, the method comprising:
replaying said message on said receiver terminal such that said replaying includes mapping at least one set of encoded symbols in said message to a corresponding sound effect in said audio dictionary so that when each of said at least one set of encoded symbols is displayed on said receiver terminal, a respective said sound effect is sounded on said receiver terminal.

12. The method of claim 11, wherein said audio dictionary is selected from the group comprising: a default dictionary installed on said sender terminal and said receiver terminal and a customized dictionary, initially installed only on said sender terminal.

13. The method of claim 12, further comprising the steps of:
uploading said customized dictionary from said sender terminal to an online repository prior to said replaying; and
downloading said customized dictionary from said online repository to said receiver terminal after receiving said message on said receiver terminal and prior to replaying said message.

14. A non-transitory computer-readable medium having stored thereon a communication software, the communication software executed by one or more processing units, the execution of the communication software by the one or more processing units performing:
receiving a message on a receiver terminal, said message composed on and sent from a sender terminal; and
replaying said message on said receiver terminal, such that said replaying includes mapping said at least one set of encoded symbols in said message to a corresponding sound effect in said audio dictionary so that when each of said at least one set of encoded symbols is displayed on said receiver terminal, a respective said sound effect is sounded on said receiver terminal.
